(19) United States
(12) Patent Application Publication
(10) Pub. No.: US 2021/0302579 A1
(43) Pub. Date: Sep. 30, 2021

(54) GROUP DOPPLER SENSOR OVER OPTICAL CARRIER

(71) Applicant: Xin Jin, Waterloo (CA)

(72) Inventor: Xin Jin, Waterloo (CA)

(21) Appl. No.: 16/917,805

(22) Filed: Jun. 30, 2020

Related U.S. Application Data
(63) Continuation-in-part of application No. 16/835,278, filed on Mar. 30, 2020.

(51) Int. Cl. G01S 17/86; G01S 7/481

(52) U.S. Cl. CPC G01S 17/86; G01S 17/931; G01S 7/4811

(57) ABSTRACT

In many applications such as automobiles on busy highways, if a lot of vehicles on road are equipped with Doppler LIDARs to help improve driving safety, no matter human-driven or autonomous-driven, when multiple LIDARs are simultaneously illuminating an object, the LIDARs signals will interfere with each other. Avoiding interference between them is a hard task. The disclosed invention of “Doppler group LIDAR” will allow LIDAR devices of this kind to inherently work together in “physical layer” without interfering one another, without sacrificing performance, and without having to rely on higher layer protocols to achieve these goals, so that all LIDARs of this kind interoperate easily and reliably.

### CROSS-REFERENCE TO RELATED APPLICATION

This application is a continuation-in-part of application Ser. No. 16/835,278, filed on 30 Mar. 2020.

### BACKGROUND OF THE INVENTION

### Field of the Invention

This invention relates generally to utility of Doppler effects, in particular, to Doppler sensors over optical carriers, also known as LIDARs, which may coexist in group with each other or one another.

### Description of the Related Art

Doppler effect has been used in Doppler radar, Doppler sonar and generally Doppler sensors to detect objects in many applications, including detecting relative speed thereof. In an earlier patent application (application Ser. No. 16/835,278), a Doppler group sensor was disclosed which included Doppler group radar and Doppler group sonar. The technology disclosed in that application allows multiple instances of such radar, sonar or sensor devices work together in the vicinity of each other at a same frequency and no need to worry about interferences among them.

Hopwood and Glezen in U.S. Pat. No. 6,697,148 disclosed a Doppler sensing device over an optical carrier (also known as Doppler LIDAR or lidar), without having to detect the light carrier coherently. When a beam from a single device of this kind bounces back from an object, this device will work as expected, but when more than one beams from a plurality of such devices bounce back from an object, these devices may interfere with each other in detection at a receiver. There is a need in the art to allow a plurality of Doppler LIDARs to work together without interfering with one another.

### BRIEF SUMMARY OF THE INVENTION

In one aspect, the invention provides embodiments of a system of Doppler group LIDARs, or group Doppler sensors over optical carrier for sensing objects, comprising at least one optical signal transmitter; and at least one optical signal receiver; wherein, each of the optical signal transmitter comprising a radio receiver, for receiving a broadcasted signal and based on said broadcasted signal to generate a frequency reference signal and/or a timing signal; a signal generator for generating a first signal of continuous wave(s) (CW) and/or a second signal of frequency modulated (FM) CW(s) base on the frequency reference signal and/or the timing signal; and a module of light source and amplitude modulator, for generating a modulated optical signal by amplitude-modulating a linear combination of the first and the second signals onto an optical carrier signal, and transmitting the modulated optical signal for object sensing; and wherein, each of the optical signal receiver comprising a radio receiver, for receiving a broadcasted signal and based on said broadcasted signal to generate a frequency reference signal and/or a timing signal; a signal generator, for generating a first signal of continuous wave(s) (CW) and/or a second signal of frequency modulated (FM) CW(s) base on the frequency reference signal and/or the timing signal; an optical detector, for detecting an amplitude of optical signals received from and associated with objects under detection, and producing a detected signal; at least one mixer, for mixing the detected signal with local replica signal(s), and each producing a mixing product signal for further processing; whereby any two of the signal generators in the system (no matter at same location or at distinct locations), if exist and active to operate, are operable to generate copies of the first signal closely identical to each other in frequency properties at any time of operation; and copies of the second signal closely identical to each other in frequency properties at any time of operation.

In another aspect, at least one embodiment of the invention provides a transmitter apparatus that functions as an active beacon or an illuminator in a system of Doppler group LIDAR, or group Doppler sensors over optical carrier, comprising a radio receiver, for locking to a broadcasted signal from an antenna, and deriving a frequency reference signal and/or a timing signal; a signal generator for generating a first signal and/or a second signal based on the frequency reference signal and/or the timing signal, and building a modulating signal based on said first signal and/or said second signal; a module of light source and amplitude modulator, for modulating said modulating signal onto a light signal, and producing a modulated light signal; whereby the transmitter apparatus is operable to generate and use, at any time instant of operation, said first signal and second signals closely identical in frequency properties to a counterpart thereof generated elsewhere in other devices within the system of Doppler group LIDAR, or group Doppler sensors over optical carrier; and transmit the modulated light signal.

In yet another aspect, at least one embodiment of the invention provides a receiver apparatus, as a standalone device or a functional subsystem in a device of combined functions, for sensing objects in a system of Doppler group LIDAR, or group Doppler sensors over optical carrier, comprising a radio receiver, for locking to a broadcasted signal from an antenna, and deriving, from the broadcasted signal, a frequency reference signal and/or a timing signal; a signal generator, for generating a first signal and/or a second signal based on the frequency reference signal and/or the timing signal; an optical detector, for converting an amplitude of optical signals from and associated with objects under sensing into a detected signal; a least one mixer, for mixing the detected signal with a local replica signal built from the first signal and/or the second signal, and producing at least one mixing product signals for further processing; and whereby the receiver apparatus is operable to generate and use, at any time instant of operation, said first and second signal closely identical in frequency properties to counterpart thereof generated elsewhere in other devices within the system of Doppler group LIDAR, or group Doppler sensors over optical carrier.

Other aspects of the invention will become clear thereafter in the detailed description of the preferred embodiments and the claims.

### BRIEF DESCRIPTION OF THE DRAWINGS

For a better understanding of the invention and to show more clearly how it may be carried into effect, reference will now be made, by way of example only, to the accompanying drawings which illustrate distinctive features of at least one exemplary embodiment of the invention, in which:

FIG. 1 illustrates a block diagram of a Doppler LIDAR (prior art);

FIG. 2 illustrates an example that a plurality of Doppler LIDARs interfere with each other in an automobile application (prior art);

FIG. 3 illustrates an example a plurality of Doppler LIDARs interfere with each other in an application of personal wearable protective device (prior art);

FIG. 4 illustrates a block diagram of one embodiment of Doppler group LIDAR;

FIG. 5 is a block diagram of another embodiment of Doppler group LIDAR;

FIG. 6 shows a block diagrams of yet another preferred embodiment of Doppler group LIDAR device, a combined device of “active beacon” and LIDAR receiver which plays both an “active beacon” function and a LIDAR receiver function in a system;

FIG. 7 illustrates an exemplary automobile application scenario of a Doppler group LIDAR system using the device embodiment of FIG. 6;

FIGS. 8A and 8B illustrate another embodiment of a Doppler group LIDAR that may be suitable for use in a highway automobile application, in which FIG. 8A shows block diagram of an illuminator device and FIG. 8B shows block diagram of a LIDAR receiver device;

FIG. 9 illustrates an exemplary use case of embodiment of FIGS. 8A and 8B;

FIG. 10 shows modifications to the embodiment in FIG. 4 to make it an embodiment of FM modulated Doppler group LIDAR;

FIG. 11 shows modifications to the embodiments in FIGS. 5, 6, 8A and 8B to make them embodiments of FM modulated Doppler group LIDAR system or subsystems thereof;

FIG. 12 illustrates a variant embodiment of FIG. 11 and FIG. 8B that separately detects the CW tone(s) and FM modulated tone(s);

FIG. 13 shows exemplary spectrum results of FM modulated Doppler group LIDAR using embodiment in FIG. 6 modified according to FIG. 11 and FIG. 12, in which FIG. 13A shows exemplary spectrum results from CW tone path, FIG. 13B shows exemplary spectrum results from sawtooth FM tone path, and FIG. 13C shows processed range detection resulting from FIG. 13A and FIG. 13B;

FIG. 14 shows an exemplary frequency sweeping waveform that alternating between CW and frequency ramp;

FIG. 15 is a flowchart showing the steps to determine both ranges (distances) and relative speeds of objects using Doppler group LIDAR system with beacon and combined CW and FMCW modulating signal.

### DETAILED DESCRIPTION OF THE INVENTION

It will be appreciated that in the description herein, numerous specific details are set forth in order to provide a thorough understanding of the invention. However, it will be understood by those of ordinary skill in the art that the invention may be practiced without these specific details. In other instances, well-known methods, procedures and components have not been described in detail so as not to obscure the invention. Furthermore, this description is not to be considered as limiting the scope of the invention, but rather as merely providing a particular preferred working embodiment thereof.

In the specification and claims, the terminologies “Doppler LIDAR (or lidar)”, “Doppler sensor over optical carrier”, “Doppler laser sensor” and “optical Doppler sensor” are used interchangeably, referring to a device that detects or senses objects using Doppler effects and light waves, including modulated light waves.

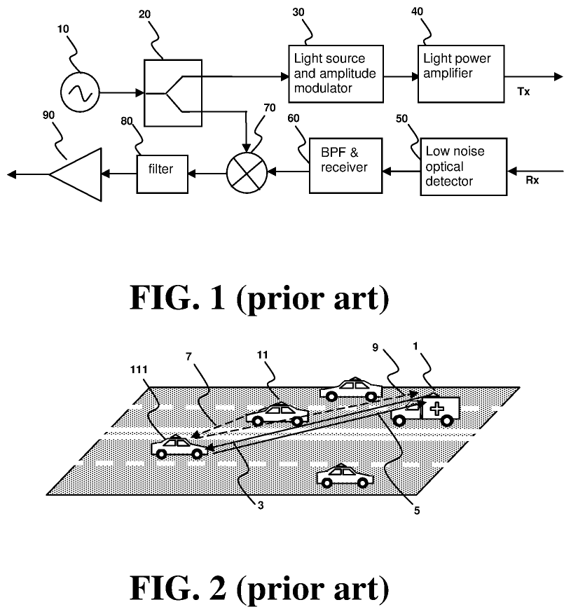

A Doppler “group LIDAR” is a family of improved Doppler LIDAR or LIDARs that are suitable to work together in proximity of each other. To explain how Doppler group LIDARs work and how Doppler group LIDARs are built, we first review the prior art, a conventional Doppler LIDAR. As illustrated in FIG. 1, a block diagram of a Doppler LIDAR (prior art, as disclosed in U.S. Pat. No. 6,697,148) is shown. This Doppler LIDAR system includes a CW (continuous wave) or FMCW (frequency modulated continuous wave) signal generator 10, which may be implemented using a crystal oscillator, a frequency synthesizer that generates required frequency or instantaneous frequency according to a reference oscillator (not shown in drawing), e.g., a DDS (direct digital synthesizer), or other types of CW or FMCW generator. For purpose of Doppler detection, the CW generator or FMCW generator preferably creates low phase noise, which is a type of random (unpredictable) phase modulation in the CW signal or FMCW signal. The CW or FMCW signal is fed to a splitter 20 to create two branches of signals that are identical to each other except that they may be different in amplitude and static phase shift. One branch of the split signal is used to modulate an amplitude of an optical signal in a “light source and amplitude modulator” module 30. In some implementation the light source and amplitude modulator may be separately implemented, for example, the light source is constant strength laser, and the amplitude modulator may be a Mach-Zehnder light modulator; in some other implementations, the light source and amplitude modulator may be a combined device, for example, implemented by a laser diode or an LED. The amplitude-modulated light output may be optionally amplified by a light power amplifier 40 before being transmitted, or be directly transmitted. Some additional optical components may also be used to facilitate the delivering of light signal into air, e.g., optical fiber, lenses and mirrors (not shown in drawing). The light wave carries the CW or FMCW signal in its amplitude over space towards objects under detection (not shown in drawing) and bounces back to receiving optical components such as light filters, mirrors, lenses and optical fiber (not shown in drawing) and is fed into a low noise optical detector (also known as photodetector) 50 to detect the optical signal amplitude. The detector output is amplified and band-pass filtered to remove components outside the CW or FMCW frequency band by BPF (band-pass filter) and receiver module 60. The amplified and filtered signal is then mixed with the other branch of CW or FMCW signal from the splitter 20 at a mixer 70 to be down converted to base band, which is also referred to in the art as IF (intermediate frequency) or zero IF (zero intermediate frequency), or baseband (in one word). Preferably the mixer is a quadrature mixer that produces both in-phase and quadrature baseband signals. The baseband signal(s) will next be filtered by a filter 80 to remove components in 2^{nd} (and higher) harmonic bands, also remove noises and interferences above the maximum Doppler/frequency shifts of interests in the application. In some applications the filter 80 may also block DC and close to DC components that represent signals bounced back from objects with zero speed relative to the LIDAR, i.e., the stationary or quasi-stationary objects. An amplifier 90 bring the signal to desired level for further processing, usually including (not shown in drawing) analog to digital converter and DSP (digital signal processing or processor).

People skilled in the art understand that, if an object is moving towards the LIDAR at a speed v, not only the light bounced back from the object and seen at the LIDAR receiver would exhibit a higher frequency (known as blue shift in astronomy), but also the modulated envelope frequency would exhibit higher frequency, by an amount referred to as Doppler shift, which is |fd|=2 fv/(c−v), where f is the frequency of the CW or FMCW signal used in modulating the light at 30; c is the light wave traveling speed (also referred to as group speed of the light wave) which is about 3×10⁸ m/s in free space (vacuum) and in air; if an object is moving away from the LIDAR at a speed v, not only the light signal bounced back from the object and seen at the LIDAR would exhibit a lower frequency (known as red shift in astronomy) but also the modulated envelope frequency would exhibit lower frequency, by the amount of |fd|=2fv/(c+v).

The Doppler shift +/−fd will cause the output signals of mixer 70 to be at frequency +/−fd. From this signal frequency fd, moving objects and moving speed thereof can be detected and derived when CW signal is used in modulating the light wave at 30. A positive fd means the object is approaching the LIDAR, and a negative fd means the object is leaving the LIDAR. The higher the |fd|, the higher the target speed is.

What happens if a plurality of such conventional Doppler LIDAR devices illuminate a same target simultaneously using a same intended CW frequency to modulate the light signal? Referring to an exemplary scenario as shown in FIG. 2, assuming a Doppler LIDAR device installed on vehicle 1 modulates light signal at frequency f1, and another Doppler LIDAR device installed on vehicle 11 modulates light signal at frequency f2, although intended f1=f2, due to part to part variation, f1 and f2 are typically slightly different, e.g., crystal oscillators usually exhibit part to part variation about 10⁻⁶ to 10⁻⁵ in relative frequency errors, and f2−f1=fe to be the frequency difference of the two LIDAR CW signals. The LIDAR signal 3 from the LIDAR on vehicle 1 hits an object vehicle 111 and bounces back (signal 5 in drawing) to the LIDAR receiver on vehicle 1 and exhibits a Doppler shift fd, which is dependent on relative speed between vehicle 1 and vehicle 111 as expected. Meanwhile LIDAR signal 7 from the LIDAR on vehicle 11 also hits the object vehicle 111 and bounces not only back to the LIDAR on vehicle 11 as intended but also to the LIDAR receiver on vehicle 1 (signal 9 in drawing). The frequency of received signal 9 at LIDAR receiver on vehicle 1 depends not only on relative speed between vehicle 1 and vehicle 111, but also depends on relative speeds between vehicle 11 and vehicle 111, and further more, it also adds the frequency difference fe. Signals from a single object (vehicle 111) will be detected as two objects on the LIDAR of vehicle 1, one is the true detection with relative speed as can be calculated from fd, another is a false detection with erroneously derived relative speed depending on fe, as well as speed of vehicle 11 which is irrelevant to the relative speed between the intended object vehicle 111 and the LIDAR device (vehicle 1).

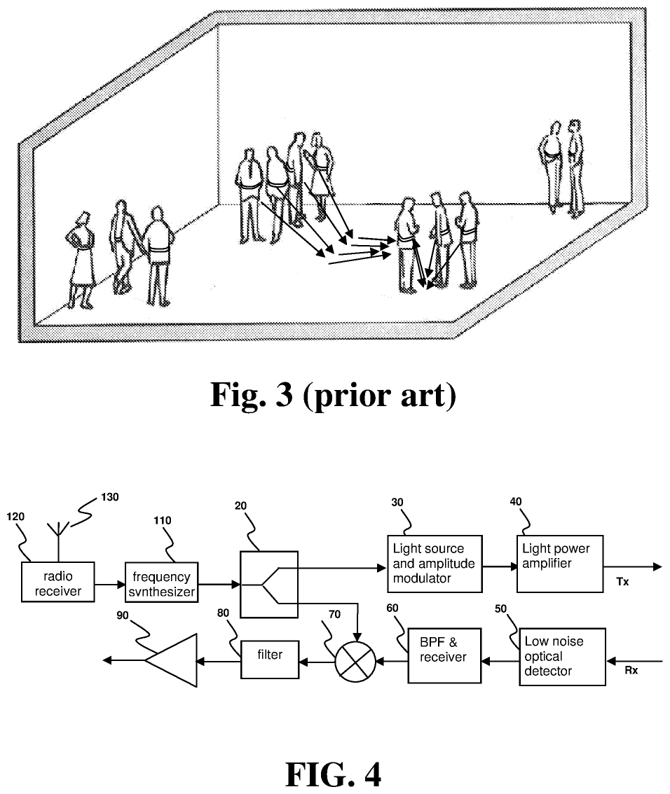

FIG. 3 shows an exemplary application scenario of Doppler LIDARs on personal wearable protective device, such as that disclosed in U.S. Pat. No. 10,154,695 B2, in which Doppler LIDARs are utilized in wearable devices that are carried by older adults to detect falling prior to hitting floor or objects, and deploy protective air bags to prevent injuries. In some use cases as shown in the figure, people carrying such devices may gather together and the Doppler LIDARs must work in the vicinity of other identical or similar Doppler LIDAR devices. Assuming a first person wearing a Doppler LIDAR that is modulated with CW signal at frequency f1, if the person is not falling, the light signal bounces back from the floor and many other stationary or slow moving objects will exhibit zero or very low Doppler shifts. If other surrounding LIDAR devices each is modulated by CW signal at their own oscillator's free running frequencies slightly higher or lower than f1 by non-zero amounts Δf1, Δf2, . . . , Δfn, . . . . These modulated light signals either bouncing back from objects or directly coming to the LIDAR receiver of the first person, the LIDAR detected Doppler shifts of these signals will be added by these amounts Δf1, Δf2, . . . , Δfn, . . . and they are likely to confuse the LIDAR to detect a false falling. In other words, such Doppler LIDAR will work in detecting falls if deployed alone, but will have trouble if deployed in a group gathering together.

Now we explain how a Doppler group LIDAR device or a Doppler group LIDAR system is built and how it will avoid the problem as described above, by way of example through embodiments.

Referring to FIG. 4, which depicts a block diagram of an embodiment of Doppler group LIDAR suitable to coexist with other Doppler group LIDAR devices of this kind. In the figure, the functions of the elements 20, 30, 40, 50, 60, 70, 80 and 90 are identical to the corresponding ones in FIG. 1 that are marked with same numerals. The radio receiver 120 and the antenna 130 are used to receive, over the air, a signal or signals that will be explained in more detail in next a few paragraphs, and by successfully acquiring and phase locking or frequency locking to the signal(s), produces a reference frequency signal and output it to the frequency synthesizer 110. Deriving from the reference signal frequency, the frequency synthesizer 110 then generates a CW signal at a desired frequency for the LIDAR. All Doppler group LIDAR devices that work together in an area are required to modulate the light carrier by an exactly same identical CW frequency. This can be achieved by 1) locking (in frequency or phase) to a same radio signal, 2) locking to signals that are locked with each other in their generation process, or 3) locked to high precision independent frequency standard sources, such as atomic clock. As shown in FIG. 3, methods 1) or 2) is used. Method 3 may be too expensive to use today (but may be possible someday in future).

In one preferred embodiment, the radio receiver 120 acquires and locks to GNSS satellite signals, e.g., GPS, GLONASS, Beidou, Galileo, or the kind. As known in the art, all these GNSS signals come from precision frequency source of atomic clocks. Although movements of satellites causing signals received at antenna 130 to exhibit significant Doppler shifts, since the GNSS simultaneously broadcasts orbit data that can accurately derive and correct these shifts after a “position fix” is achieved, there has been matured technology to generate accurate reference clock based on GNSS, including correction of Doppler shifts caused by moving of radio receiver 120 itself, known in the art as GNSS disciplined oscillator.

In another embodiment, the radio receiver 120 may acquire and lock to ground station signal(s) of standard frequency and time signal service (SFTS) such as defined in Article 1.53 of the International Telecommunication Union's (ITU) Radio Regulations (RR), or space station signals of standard frequency and time signal-satellite service (SFTSS) such as defined in Article 1.54 of ITU RR.

In yet another embodiment, all coexisting member devices of Doppler group LIDARs may acquire and lock to a commonly agreed radio signal. This radio signal may be originally for purpose of other services. This signal does not have to provide an absolute accuracy of frequency, but ensures frequency synchronization among all coexisting member devices of the group LIDARs. For example, the devices may all lock to the carrier of an AM radio station, a TV station, or a cellular base station, etc. A protocol needs to be in place to ensure member devices will correctly identify, among potentially many broadcasted signals, which one of them they all lock to. One simple example is a lookup table of signals ordered by priority. Such lookup table may also list only one signal to use.

In an alternative embodiment, in applications such as that shown in FIG. 3, in which users of Doppler group LIDAR are stationary or quasi-stationary, an autonomous procedure may be performed to make all users in a cluster synchronized and make the group LIDAR work. The procedure needs to pick one of the member devices (referred to as leader) in a group LIDAR cluster to transmit a reference signal by radio waves or by light waves or by acoustic waves, and all other member devices are synchronized with this reference signal (referred to hereinafter as leader reference signal). The leader reference signal may be transmitted using a separate dedicated antenna (not shown in drawing, e.g. an omnidirectional antenna) or with a separate dedicated light channel (not shown in drawing), or with a sound transducer. The leader reference signal must have a predetermined frequency relationship with the CW signal used by the LIDARs and known to all member devices.

In an alternative embodiment, regional special purpose transmitter stations, referred to, in this application, as reference broadcast stations, are built to serve local Doppler group LIDAR users in the region. These special purpose stations will broadcast predefined frequency reference signals authorized by radio spectrum regulation authorities and follow commonly agreed standard. All member devices of Doppler group LIDAR are required to synchronize with at least one of the reference signals broadcast by a reference station and follow a commonly agreed standard in deriving their CW frequency from the reference signal for modulating their light carrier. Preferably the reference broadcast stations also broadcast a time mark signal and station geographical position information, for example, in terms of Latitude and longitude as well as altitude. The geographical position information of the station may be used for correcting Doppler shift of the frequency reference signal as seen at receiver radio 120, caused by movement of the radio receiver 120. More preferably, multiple such stations are deployed around serving region and each device of a Doppler group LIDAR system will receive 3 or more such signals from multiple directions. In such condition, even if the device is moving, based on timing mark and geographical location information broadcasted, the device is able to accurately correct Doppler shifts in received reference broadcast signals.

When Doppler LIDAR devices as in FIG. 3 are all synchronized and deployed in application scenario of FIG. 3, what will happen? Assuming a first person wearing a Doppler LIDAR transmitting light signal modulated by a CW at frequency f1, if the person is not falling, this signal bounces back from the floor and many other stationary or slow moving objects will exhibit zero or very low Doppler shifts, which will cause the mixer 70 to output a DC and very low frequency fluctuations, and they will be blocked by the filter 80. As other surrounding LIDAR devices are all synchronized, each of them also transmits at the frequency equal to f1 with only very small phase noise (random frequency drifts). These signals, either bouncing back from stationary objects and slow-moving persons, or line of sight directly coming to the LIDAR receiver of the first person, if the LIDAR receiver of the first person has sufficient dynamic range to handle stronger signals coming through line of sight paths, the LIDAR detected Doppler shifts of these signals will also be zero or very low frequency and will be blocked as well by filter 80. Only when the person falls and the fast moving will get high Doppler shifts be detected. It is true, however, when a second person falls, who is close to the first person, the LIDAR device wearing on the first person may also detects a falling. In other words, for the application scenario of FIG. 3, the quasi-synchronized LIDARs of FIG. 4 do detect true falls and would no longer falsely detect falls due to oscillator frequency errors, in most cases except, by chances, the special cases as will be explained in the next paragraph.

Since all member devices in a cluster are synchronized in their CW modulating signals, the CW signals are coherent with each other. By chances, more than one beams of light signals, from light transmitter of self device as well as one (or more) member LIDAR transmitter(s) and bouncing back from objects under detection or line-of-sight directly from a LIDAR transmitter, may happen to arrive at the optical detector 50 with overall amplitude in destructive way and cancel out. When such chances happen, the detection may fail. Although such chance is very low, to further reduce such failing chances, an improved embodiment will be described in the next paragraph.

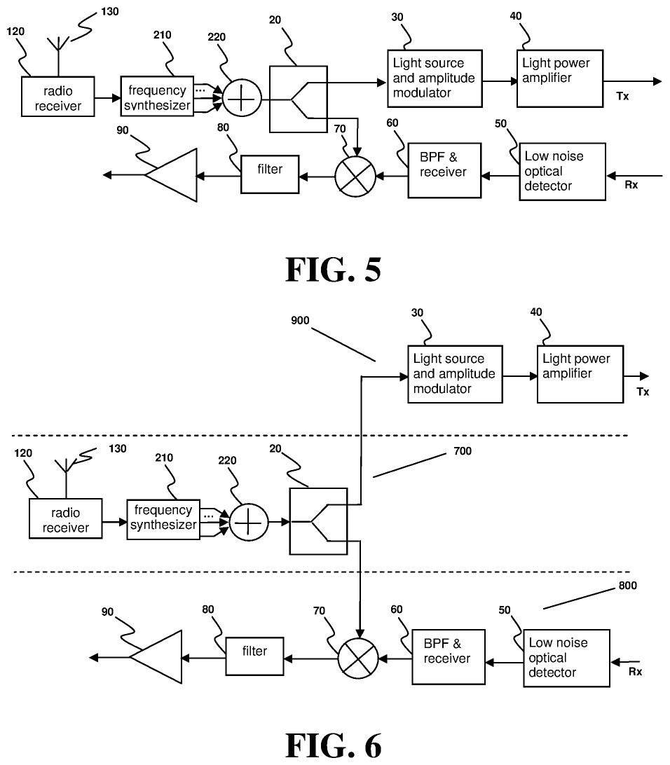

FIG. 5 is another preferred embodiment of Doppler group LIDAR, suitable to coexist with other Doppler group LIDARs of this kind. In the figure, the functions of the elements of 120, 130, 20, 30, 40, 50, 60, 70, 80 and 90 are identical to the corresponding ones in FIG. 4 that are marked with same numerals. The frequency synthesizer 210 is modified to produce more than one outputs, and the output signals are linearly combined in adder 220. The output signals of synthesizer 210 each has a distinct CW frequency and the frequency difference between any pair of them shall be more than twice of the maximum Doppler shift of concern in the application plus a guard band. This way, between them they will not interfere with each other. Furthermore, it is desirable that any of the frequency of synthesizer 210 output shall be away from n times of another frequency of synthesizer 210 output by at least amount of 2n times [maximum Doppler of concern plus guard band]. It can be understood by skilled people in the art that the LIDAR in FIG. 5 simultaneously transmit multiple tones and detection can be achieved through any one of the tones. As a member of Doppler group LIDAR cluster, each LIDAR device shall transmit at a number of frequencies that are pre-agreed among the members of the cluster. As such, all devices are synchronized in their transmitting frequencies without being confused as Doppler shift. It can also be understood by those skilled in the art that, the chance of multiple tones from amplitude modulated light beams of LIDAR devices all happen to simultaneously cancel is very minimal. Since cancelling tones must also happen to have nearly same Doppler shift, in practice, duel tones would be sufficient in typical applications. As can be realized by the skilled in the art, the embodiment in FIG. 4 is a degeneration special case of the embodiment in FIG. 5.

For purpose of facilitating identification of original signal source in processing Doppler information in the system, a time-variant artificial dithering may be added to the modulation index of the light source and amplitude modulator 30 (not shown in drawing) in embodiments of FIGS. 4 and 5, or be added into the its input signal (not shown in drawing); the dithering waveform may, for example, be low frequency random variations or a low data rate digital ID of the LIDAR device.

FIG. 6 shows a block diagram of another preferred embodiment of Doppler group LIDAR device, wherein the upper part 900 is the “active beacon” part of the LIDAR device and the lower part 800 is the receiver part of the LIDAR device, whereas the middle part 700 is the common part shared by the active beacon function and receiver function. This embodiment may be used in an automobile application and fully-automated (unmanned) cargo terminal application, for example. The active beacon part, 900 together with 700, transmits a beacon signal for purpose of being seen by other LIDARs. In an automobile application, this part is desirable to be installed on every vehicle on road that supports such feature. Like a lighthouse, the beacon signal is for purpose of letting others “see” it rather than illuminating objects sounding it. The LIDAR receiver part, 800 together with 700, detects and measures signals coming from active beacons of other devices (installed on other vehicles, for example).

The active beacon part 700 and 900 actually is nearly identical to the transmitting path in FIG. 5, except that the transmitted light signal may be desirable to be emitted to all directions, rather than forming a narrow beam, e.g., through optical components (not shown in drawing). And the light source and amplitude modulator module 30 may use a light source to facilitate this omnidirectional emitting task, e.g., using an LED as light source. That is because the beacon, in many applications, is desired to be seen by (other) LIDARs from any direction around. As in previous embodiments, the CW frequency will be quasi-frequency-synchronized so that individual beacons in a cluster of beacon devices all modulate their light signals by identical CW frequency or frequencies. Again, it is desirable to use more than one CW frequencies simultaneously to reduce the chance that signals from two or more light beacons in cluster arrive at a LIDAR receiver to happen to cancel each other in their amplitudes waveforms and causing misdetection. For purpose of facilitating identification of a beacon (to be further discussed hereinafter), a time-variant artificial dithering may be added to the modulation index of the light source and amplitude modulator 30 (not shown in drawing), or be added into the its input signal (not shown in drawing); the dithering waveform may, for example, be low frequency random variations or a low data rate digital ID of the beacon device.

The receiver part 700 and 800 in fact is identical to the receiving path in previous embodiments (FIG. 5), however, in this embodiment, the receiver is intended to detects signal coming directly from (other) radio beacons rather than detecting the signals bounced from passive objects. For typical objects like cars, a reflected path usually is weaker than a line-of-sight direct path by 15 dB or more, dynamic range of the receiver path in FIG. 6 is desirably optimized for ling-of-sight signal strengths for the detection range in design. Since every active beacon is quasi-synchronized and modulates at an identical CW frequency (or a sets of identical CW frequencies), a LIDAR receiver will observe Doppler shifts from any of them only dependent on the relative speed between a beacon under detection and the receiver, not depending on factors such as frequency error and drifts and moving speed of any other objects around. Again, a misdetection may happen if signals from more than one beacons happen to exhibit nearly identical Doppler shift amount and cancel one another in combined amplitude at the optical detector 50. The method to reduce such chances of misdetection is again to simultaneously use more than one tone frequencies for detection as explained in previous embodiment of FIG. 5. People ordinarily skilled in the art will be able to derive Doppler and speed relations in such beacon and receiver use case base on principles of Doppler effects, and will not be detailed herein.

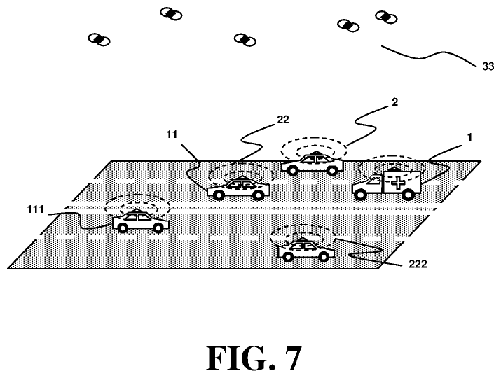

FIG. 7 illustrates an exemplary automobile application scenario of a Doppler group LIDAR system using the device embodiment of FIG. 6. In the example, all vehicles on road (such as 1, 11, 111, and so on) are equipped with active beacons that transmit a light beacon signal (2, 22 or 222 and so on) modulated by a tone (or a set of tones) at precisely an identical frequency (or an identical set of frequencies), this is achieved by using their built-in receiver (not shown in drawing) to lock to navigation signals from GNSS 33 and discipline their built-in local oscillators (not shown in drawing). LIDAR receivers, also equipped with by the vehicles (such as 1, 11, 111, and so on) then detect the optical beacon signals and measure Doppler shifts in their modulated CW(s). Since all beacons use a same (set of) tone frequency or frequencies, all LIDAR receivers only need to detect light signals at the same (set of) modulating CW frequency or frequencies, and no higher layer protocols are required to coordinate use of CW frequencies in beacons and tuning to these frequencies in receivers.

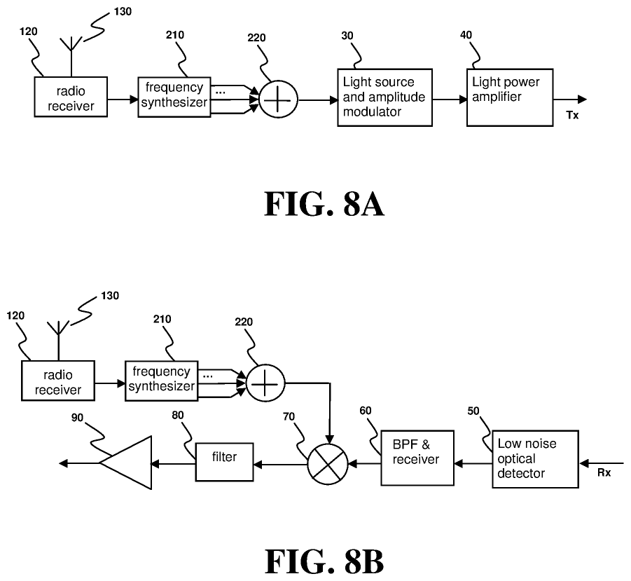

FIGS. 8A and 8B illustrate another embodiment of Doppler group LIDAR devices that make the system maybe suitable for use in highway automobile application. In particular, FIG. 8A shows an illuminator device and FIG. 8B shows a LIDAR receiver device.

Referring now to FIG. 8A, block diagram of illuminator device of the Doppler group LIDAR system in the preferred embodiment. In the block diagram, elements of 120, 130, 210, 220, 30 and 40 are identical to the corresponding ones in FIG. 5 with same numerals. Comparing it with transmitter path of FIG. 5, only splitter 20 is eliminated in FIG. 8A and the rest are identical to the transmitter path in FIG. 5. The illuminator devices are installed on stationary platforms to radiate light signal modulated by CW tone (or tones) to objects under LIDAR detection so that the signals bouncing back from these objects will be detected by LIDAR receivers, which may be separately installed on board of moving platforms (such as cars and cargo vehicles). Again, all illuminator devices are modulated by one tone or a number of tones at precisely identical frequency or frequencies, so that frequency differences (of corresponding tone signals) between all illuminator devices are zero and will not be erroneously detected as a Doppler shift. Also again, as did in the embodiment of FIG. 5, more than one tones may be used simultaneously to modulate the light signal for illuminating objects under detection, so as to reduce chances of misdetections caused by tone signals coming from more than one illuminators (bounced by objects or directly through line-of-sight path) happen to cancel one another in amplitude envelope at a receiver optical detector. For purpose of facilitating identification of an illuminator in processing Doppler information in the system, a time-variant artificial dithering may be added to the modulation index of the light source and amplitude modulator 30 (not shown in drawing), or be added into the its input signal (not shown in drawing); the dithering waveform may, for example, be low frequency random variations or a low data rate digital ID of the illuminator device.

Referring now to FIG. 8B, block diagram of receiver device of the Doppler group LIDAR system in the preferred embodiment. In the block diagram, elements of 120, 130, 210, 220, 50, 60, 70, 80, and 90 are identical to the corresponding ones in FIG. 5 with same numerals. Comparing it with the portion of FIG. 5 related to receiver, only splitter 20 is eliminated in FIG. 8B and the rest are identical to the portion in FIG. 5. The LIDAR receiver devices may be installed on board of moving platforms (such as cars and cargo vehicles) to detect reflected signals from objects under detection. These reflected signals originally come from illuminators which may be installed physically away from the receivers. Again the detection may be simultaneously performed at more than one CW tone frequencies to reduce chances of misdetection caused by multipath/multisource cancellation as explained also in previous embodiments. People ordinarily skilled in that art will be able to derive Doppler and speed relations in such stationary illuminator and moving receiver use case base on principles of Doppler effects, and will not be detailed herein.

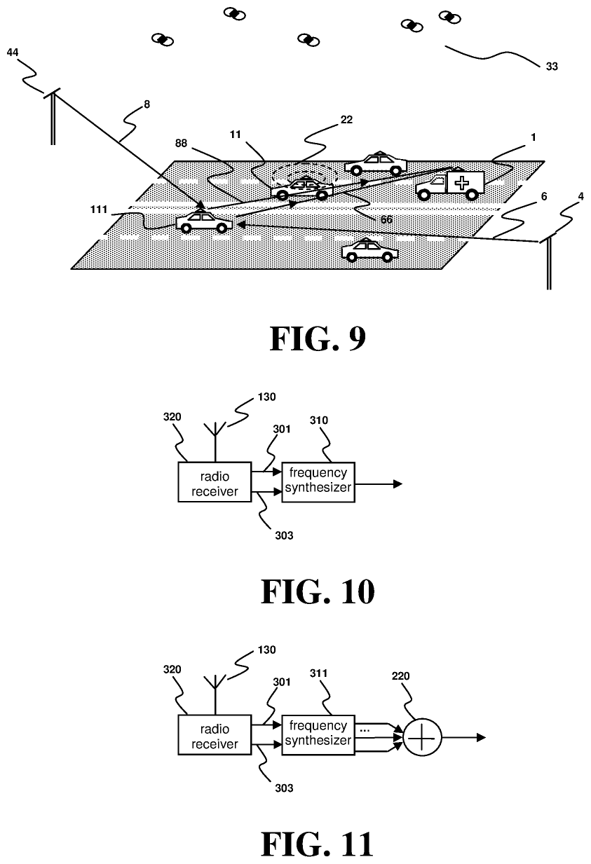

FIG. 9 illustrates an exemplary use case of embodiment of FIGS. 8A and 8B, in highway automobile application. Illuminators (such as built by way of FIG. 8A) are installed on roadside towers (e.g., 4 and 44 in drawing) or above road structures (not shown in drawing) along the highway, which may lock to signals from GNSS 33 and produce CW tone (or tones) identical in frequency (or frequencies) to modulate light signals emitted towards automobiles on road (e.g., signal paths 6 and 8 shown in drawing). The light signals hit an automobile (e.g. vehicle 111) and are reflected to the air, such as signal paths shown in drawing 66 and 88, they are received by LIDAR receivers installed on board of vehicles (e.g. that on vehicle 1), the LIDAR receivers may be built by way of FIG. 8B and they may also be locked to GNSS signals from GNSS satellites 33. Receiving the reflected signals (e.g. 66 and 88), the receiver is able to detect the Doppler shift of the modulated envelope in the light signals. On the road, there may be mixed type of vehicle objects, some of them (e.g. vehicle 11) may be equipped with an active beacon signal transmitter as described in FIG. 6, sending in air an optical beacon signal 22, a LIDAR receiver such as that on board of vehicle 1 should also be able to detect the beacon signal since they are modulated by a same (set of) CW frequency or frequencies as what the illuminators use. For purpose of reliable detection of both reflected signals and actively transmitted active beacon signals, the beacon transmitted power is desirably regulated to similar levels as the reflected signal power to optimize LIDAR receiver link budget. Alternatively, the active beacons may be assigned to be modulated by a frequency (or a set of frequencies) different from what the illuminators use, and a LIDAR receiver is designed to receive both type of signals. In the drawing although it illustrated only one LIDAR receiver on vehicle 1 detecting signals, in fact every vehicle may be equipped with a LIDAR receiver and they should work in the same way as that on vehicle 1. They form a group LIDAR cluster without interfering with each other although they are in proximity of each other.

It is known in the art that using frequency modulated signal to replace CW would enable a Doppler LIDAR to detect not only object speed but also object range (distance). The Doppler group LIDAR disclosed herein is also able to incorporate that technology, as will be described herein below.

Referring to FIG. 10, which shows modifications to the embodiment in FIG. 4 to make it an embodiment of FM modulated Doppler group LIDAR. The subsystem shown in FIG. 10 will replace corresponding subsystem of elements 110, 120, and 130 in FIG. 4, and keep all the rest in FIG. 4 as they were. In FIG. 10, the antenna 130 is identical to that in FIG. 4. Radio receiver 320 however not only outputs a frequency reference signal 301 as in FIG. 4 but also a precise timing indicating signal 303. The timing signal 303 may consists of a time marking pulse whose edge (e.g. rising edge) marks beginning of a predetermined time interval. The timing signal 303 may further consists of an n-bit time counter value (e.g., a time counter value associated with GPS time). The timing may be derived from GNSS signals as known in the art, or may be derived from ground station signal(s) of Standard frequency and time signal service (SFTS) as defined in Article 1.53 of the International Telecommunication Union's (ITU) Radio Regulations (RR), or space station signals of Standard frequency and time signal-satellite service (SFTSS) as defined in Article 1.54 of ITU RR, or derived from other suitable broadcasted signals, including reference signals from reference broadcast stations built specifically for this purpose. Based on the precise reference frequency and timing signals 301 and 303, the frequency synthesizer 310 will produce a FM modulated output signal and makes sure every member device in the Doppler group LIDAR cluster reproduces this FM modulated signal exactly identically in their instantaneous frequency at any time. Such frequency synthesis technology is known in the art, e.g., those based on DDS (direct digital synthesis), and is not explained in further detail herein. In some applications, it may be desirable to alternate over time between sending FM signal and CW signal, and such arrangement may also be time-synchronized among all member devices in cluster precisely, by following a commonly agreed protocol. For example, when the timing signal 303 ticks, start sending signal configuration A if the time counter value of signal 303 or a system timing counter (not shown in drawing) is a odd number, and sending signal configuration B if the counter is an even number, and so on. As will be appreciated by people skilled in the art, the signal used for modulating light waves may be frequency modulated in sawtooth wave, triangle wave, sine wave or other types of waveforms, per application requirements.

Referring to FIG. 11, which shows modifications to the embodiments in FIGS. 5, 6, 8A and 8B to make them embodiments of FM modulated Doppler group LIDAR systems. The subsystem shown in FIG. 11 will replace corresponding subsystem of elements 120, 130, 210 and 220 in FIGS. 5, 6, 8A and 8B, and keep all the rest in FIGS. 5, 6, 8A and 8B as they were, no matter in a LIDAR transmitter, receiver, active beacon, or an illuminator. The subsystem in FIG. 11 works in same way as the one in FIG. 10 except that, frequency synthesizer 311 generates more than one signals, and at least one of the signals is FM modulated at least over some time intervals. Again, in all devices of the group LIDAR cluster, all (active) signals from any instances of the frequency synthesizers 311 in devices of the cluster are precisely time synchronized (or quasi-synchronized), i.e., at any time instant, the instantaneous frequency is identical between any two corresponding signals of any two devices in the cluster. Other feathers are same as described for FIG. 10 and will not be repeated herein.

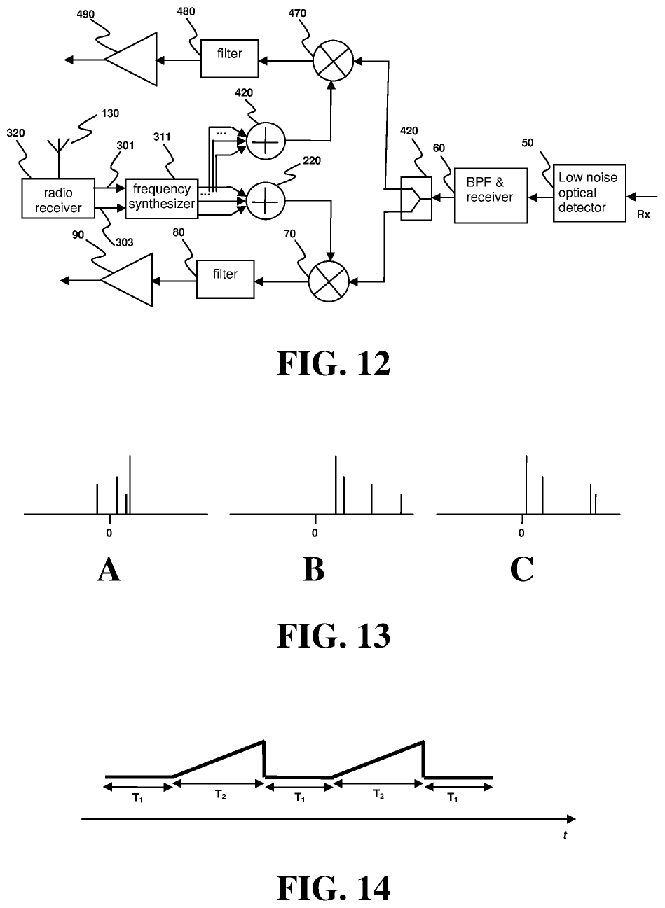

In some embodiments, not all tones are FM modulated. In a LIDAR receiver, it may be desirable to separately detect the CW tone(s) and FM modulated tone(s). As an example, FIG. 12 shows a variant embodiment of FIG. 11 and FIG. 8B that separately detects CW tone(s) and FM modulated tone(s). In FIG. 12, the generated CW tones from frequency synthesizer 311 are fed to combiner 220 as did in FIG. 8B (if only one tone is CW tone, combiner 220 is not required), but all rest FM modulated tones are fed to another combiner 420 (if only one tone is FM modulated tone, combiner 420 is not required). The combined signal of CW tones is fed to mixer 70 as did in FIG. 8B, but the combined signal of FM modulated tones is fed to a separate mixer 470. Received signal from optical detector 50 after amplified and filtered by BPF receiver 60 is split into two branches by splitter 420 and the outputs are fed to the mixers 70 and 470. Functions of filter 480 and amplifier 490 are same as their counterparts 80 and 90, respectively. The output signal from amplifier 90 is baseband signal from CW tones and that from amplifier 490 is baseband signals from FM modulated tones, they may be passed to an analog to digital converter and DSP module (both not shown in drawing) for further processing. Similarly, people skilled in the art understand that embodiments in FIG. 5 and FIG. 6 may also be implemented as described in FIG. 12 to separately mixing CW tone(s) and FM tone(s), and will not be repeatedly described herein.

How does a FM Doppler group LIDAR system detect both speed and range (distance)? This paragraph assumes using the embodiments of active beacon as shown in FIG. 6 with modification shown in FIG. 11, and a variant of receiver 800 using separate mixing structure like in FIG. 12. Assuming all devices use multi-tones to modulate the light signal, and some of the tones is/are CW and some other tone(s) is/are FM swept using sawtooth waveform at a constant sweeping rate of Δf Hz/second increasing for T seconds then jumps back by amount (Δf·T) Hz. At any time instant, all light beacons under detection in the cluster as well as all LIDAR receivers are generating exactly same frequency in producing the CW and FMCW modulating signals as well as local oscillator signals fed into mixers (70, 470). Assume arbitrary number of objects are moving around a LIDAR receiver in cluster, each carrying an active beacon as described. The CW tone(s) modulating light signal by a beacon seen at the LIDAR receiver will exhibit a Doppler shift dependent on the beacon speed relative to the LIDAR receiver. Multiple beacons will be detected as Doppler shift lines in spectrum analysis results, e.g., through FFT (Fast Fourier transform). FIG. 13A gives an example of Doppler shifts of four beacons. Each line represents a beacon and its associated object, the lines with positive frequency shifts represent objects getting closer to the LIDAR receiver and negative frequency shifts represent objects getting farther to the LIDAR receiver. The height of the lines represents received signal strength from a beacon. From the frequency shifts, object speeds relative to the receiver can be calculated. Next, we need to detect the range (distance) of the beacon installed objects. The FM swept tone(s) arriving at a receiver optical detector is delayed due to light wave propagation. The FM swept modulating tone(s) of a beacon with distance d away from the receiver will take d/c seconds to arrive at the receiver detector, where c is the propagation speed of light. In other words, locally generated LO (local oscillator) signal, although exactly identical to the beacon-used modulating signal in frequency at any time, is actually mixing with beacon signal envelope tone(s) generated d/c seconds ago. Due to sweeping, the instantaneous frequencies between them has shifted by Δf·d/c Hz, furthermore, due to beacon installed objects and/or the receiver may be moving, in addition to the shifting amount caused by sweeping and propagation delay, they also added amount of Doppler shifts. Spectrum analysis of the LIDAR receiver output may display a spectrum like FIG. 13B. This is an intermediate result that contains both range (distance) and speed information, for purpose of method illustration only. We need to deduct the amount of Doppler frequency shift to get the net shift caused by signal propagation delay and FM sweeping, i.e., to deduct the Doppler shift obtained from the CW signal detection (of corresponding beacon). Among the multiple lines in FIGS. 13 A and B, we need to correctly identify which line in FIG. 13A and in FIG. 13 B corresponds to a given beacon. Various methods can accomplish this task, some examples will be discussed next. Assuming we correctly identified them one by one, then deducts the Doppler caused shifts, we can get range (distance) caused shifts shown, by way of example, in FIG. 13 C, in which, the horizontal axis value of lines represent the ranges (distances) of the beacons to the receiver. Combining the results from FIGS. 13 A and C, the CW and FMCW modulated Doppler group LIDAR is able to detect and report both relative speeds and distances of multiple beacon-installed objects.

As discussed, we need to deduct Doppler amount of individual beacon signal, from spectrum analysis. How can we identify each spectrum lines in CW baseband and FM modulated baseband channels and associate them correctly for each of the detected objects (beacons)? One way is by strength. Since CW tone(s) and FM modulated CW tone(s) from a given beacon are coming from same LIDAR transmitter, received by same optical detector and receiver chain, and two arms of mixers may also be designed with nearly same gain, spectrum lines from CW tone(s) and FM tone(s) from a same beacon should be detected at nearly equal strengths, but spectrum lines from different beacons would vary in their strengths, depending on factors such as distance, effective radiated transmitted power in the direction of receiver, receiver aperture beam pattern in the direction of the beacon. Most cases they are easy to identify and distinguish. However, it is still possible that signals from two beacons are detected at same strength and cannot uniquely detect their speeds and distances. One way to facilitate the identification is to let beacons add some dithering modulation, such as low frequency random (random between beacons) amplitude modulation index over time (but identical to all CW and FM tones in same beacon). This way, the pair of spectrum lines respectively detected in CW baseband path and FM baseband path that always vary their strengths in a same way (i.e., statistically strong correlation) must come from a same beacon. Another way of dithering is to use a digital ID of beacons to be amplitude modulated on CW and FMCW tone(s), or phase/frequency modulated into the CW and FMCW tone(s). Other methods are also possible.

If using single tone only in the beacon embodiment of FIG. 6 (modified with FIG. 10), how can we use FM modulation to detect both speeds and range (distance) in a group LIDAR cluster? One way to achieve this is to alternate over time CW and sawtooth frequency sweep, for example, to use tone frequency that varies as shown in FIG. 14. For an interval T₁ the synthesizer generates CW signal, and then for an interval of T₂ the frequency stats to ramp at a constant rate of Δf Hz/second, then jumps back to the CW frequency for another interval T₁, and ramp again for an interval of T₂ and repeats on. All devices in a cluster are synchronized to repeat the frequency cycle. During a CW interval, Doppler shifts of target beacons are measured, which obtains relative moving speeds between the receiver and each of the target beacons in cluster; during the ramping intervals frequency shifts caused by propagation delay and frequency sweep plus their Doppler shifts are measured for the target beacons, then this measured frequency shifts are deducted by their Doppler shift value individually for each beacon, obtaining the net shifts caused by propagation delay and frequency sweep, their range (distance) can be calculated. Again, in the process, pairs of spectrum lines between the two intervals need to be correctly identified to detect correct amount of Doppler shift. In this process, lines maintaining same magnitude before and after a frequency jump are from a same beacon. If no two lines showing same strength at the moment of frequency jump, there is no ambiguity to find solutions. To reduce chances of ambiguous solutions, similar to the method described in previous paragraph, low frequency random (between beacons) amplitude modulation index may be added to beacon transmitting signals (although random over time, maintaining constant for T₁+T₂, across the jump points) and if at one frequency jump still there is ambiguity, wait for another cycle to identify again. Drawback of using single tone signal is, the Doppler deducted during ramp actually is from the other time period, if object speed changes quickly during this period, will introduce some error due to the misalignment.

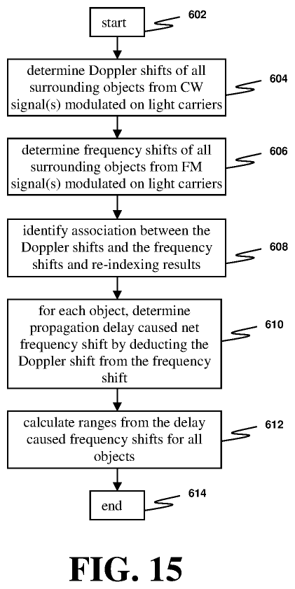

FIG. 15 is a flowchart summaries the steps to determine both ranges (distances) and relative speeds of objects using Doppler group LIDAR system with beacon and combined CW and FM signals modulating onto a light carrier, as discussed in previous paragraphs. Beginning from step 602; first, from mixing product signals of CW tone(s) detected from received light signals, at step 604, a group LIDAR receiver is able to determine a first array containing Doppler shifts for detected objects; next, from mixing product signals of FM swept tone(s) detected from received light signals, at step 606, the receiver is able to determine a second array of frequency shifts for the objects, note however, the array elements for the first array and the second array may not be indexed by corresponding objects; next at step 608, the association of elements in the two arrays need to be identified, for example, using methods described in previous paragraphs, or by other methods, and the array indexes are rearranged to make correct object association between first array and rearranged second array; at step 610, the (rearranged) second array minus the first array element by element, obtain a third array that contains net frequency shifts caused by propagation delay of objects. From this third array, we can calculate ranges (distances) of objects (step 612), so the first and the third arrays provide both relative speed and distance of detected objects, the task ends at step 614.

With the above describe examples, people of ordinary skill in the art would be able to work out detection methods for group users/objects for other embodiments of CW and/or FMCW Doppler group LIDAR systems, such as those in FIG. 4, FIG. 5, FIG. 6 (may be mixed with non-beacon objects), as well as FIGS. 8 A and B, as modified according to FIG. 9 or 10, or FIG. 12, with or without beacon, with or without illuminator, with LIDAR devices being quasi stationary or moving, mixed device types, etc. Since the use cases are application dependent and there exist a lot of combinations, elaborating all cases is not necessary. Furthermore, detection methods and processing algorithms are not unique, people of ordinary skill in the art would be able to work out variations and proprietary algorithms.

Certain terms are used to refer to particular components. As one skilled in the art will appreciate, people may refer to a component by different names. It is not intended to distinguish between components that differ in name but not in function.

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances.

Also, the term “couple” in any form is intended to mean either a direct or indirect connection through other devices and connections.

It should be understood that various modifications can be made to the embodiments described and illustrated herein, without departing from the invention, the scope of which is defined in the appended claims.

I claim:

1. A system of Doppler group LIDARs, or group Doppler sensors over optical carrier for sensing objects, comprising:
at least one optical signal transmitter; and
at least one optical signal receiver;
wherein, each of the at least one optical signal transmitter comprising:
a first radio receiver, for receiving at least one broadcasted signal and based on said broadcasted signal to generate at least one of a frequency reference signal and a timing signal;
a first signal generator, coupled to the radio receiver, for generating at least one of a first signal and a second signal base on at least one of the frequency reference signal and the timing signal; and
a module of light source and amplitude modulator, coupled to the signal generator, for generating a modulated optical signal by amplitude-modulating one of the first signal, the second signal, or a linear combination of the first and the second signals onto an optical carrier signal, and transmitting the modulated optical signal for object sensing;
and wherein, each of the at least one optical signal receiver comprising:
a second radio receiver, for receiving at least one broadcasted signal and based on said broadcasted signal to generate at least one of a frequency reference signal and a timing signal;
a second signal generator, coupled to the second radio receiver, for generating at least one of a first signal and a second signal base on at least one of the frequency reference signal and the timing signal;
an optical detector, for detecting an amplitude of optical signals received from and associated with objects under detection, and producing a detected signal;
at least one mixer, each coupled to the second signal generator and the optical detector, for mixing the detected signal with one of the first signal, the second signal, or the linear combination of the first and the second signals, and each producing a mixing product signal for further processing;
whereby any two of the first or second signal generators in the system, if exist and active to operate, are operable to generate:
copies of the first signal, if active, closely identical to each other in frequency properties at any time of operation; and
copies of the second signal, if active, closely identical to each other in frequency properties at any time of operation.

2. The system of Doppler group LIDARs, or group Doppler sensors over optical carrier of claim Error! Reference source not found., wherein the broadcasted signal is at least one of:
a Global Navigation Satellite System (GNSS) signal;
a GPS signal;
a GLONASS signal;
a Beidou signal;
a Galileo signal;
a standard frequency and time signal service (SFTS) signal;
a standard frequency and time signal-satellite service (SFTSS) signal;
a wireless signal that is locked in frequency to a GNSS signal; and
a wireless signal that is commonly available to all of the first and the second receivers in the system.

3. The system of Doppler group LIDARs, or group Doppler sensors over optical carrier of claim Error! Reference source not found., wherein the first signal generator is further operable to generate the first and second signals, if active, with magnitudes thereof based on at least one of:
a low data rate digital ID data sequence of said optical signal transmitter; and
a low frequency random waveform, generated independently in said optical signal transmitter.

4. The system of Doppler group LIDARs, or group Doppler sensors over optical carrier of claim Error! Reference source not found., wherein the first and the second signal generators are shared as one module and the first and the second radio receivers are shared as one module.

5. The system of Doppler group LIDARs, or group Doppler sensors over optical carrier of claim Error! Reference source not found., wherein the first signal is at least one of:
a continuous wave (CW) signal;
a CW signal that is gated on and off over time; and
a linear combination of a plurality of CW signals at distinct frequencies.

6. The system of Doppler group LIDARs, or group Doppler sensors over optical carrier of claim Error! Reference source not found., wherein the second signal is at least one of:
a frequency modulated signal; and
a linear combination of a plurality of frequency modulated signals at distinct frequencies.

7. The system of Doppler group LIDARs, or group Doppler sensors over optical carrier of claim Error! Reference source not found., wherein said linear combination of the first and the second signals includes linear combination coefficients that are time varying.

8. The system of Doppler group LIDARs, or group Doppler sensors over optical carrier of claim Error! Reference source not found., wherein the plurality of frequency modulated signals maintain one of the following quantities a constant or constants:
a difference or differences of instantaneous frequencies between any pair thereof; or
a ratio or ratios of instantaneous frequencies between any pair thereof.

9. The system of Doppler group LIDARs, or group Doppler sensors over optical carrier of claim Error! Reference source not found., wherein at least one of the at least one optical signal transmitter functions as an active beacon transmitter, and is attached to an object for being detected by said at least one optical signal receiver physically located away from this instance of active beacon transmitter.

10. The system of Doppler group LIDARs, or group Doppler sensors over optical carrier of claim Error! Reference source not found., wherein at least one of the at least one optical signal transmitter functions as an illuminator transmitter, and is operable to transmit the modulated optical signal towards objects to be sensed.

11. The system of Doppler group LIDARs, or group Doppler sensors over optical carrier of claim Error! Reference source not found., wherein the illuminator transmitter is installed on at least one of:
a stationary platform; or
a movable reference platform.

12. A Doppler group LIDAR receiver apparatus in a system of Doppler group LIDAR, or group Doppler sensors over optical carrier for sensing objects, comprising:
a radio receiver, for locking to a broadcasted signal from an antenna, and deriving, from the broadcasted signal, at least one of a frequency reference signal and a timing signal;
a signal generator, coupled with the radio receiver, for generating, based on the at least one of the frequency reference signal and the timing signal, at least one of a first signal and a second signal;
an optical detector, for converting an amplitude of optical signals from and associated with objects under sensing into a detected signal;
a least one mixer, coupled with the optical detector and the signal generator, for mixing the detected signal with at least one of a first signal, a second signal and a linear combination of the first and the second signals, and producing at least one mixing product signals for further processing; and
whereby the receiver apparatus is operable to generate and use, at any time instant of operation, said at least one of the first signal and the second signal closely identical in frequency properties to any counterpart thereof generated elsewhere in other devices within the system of Doppler group LIDAR, or group Doppler sensors over optical carrier.

13. The Doppler group LIDAR receiver apparatus of claim Error! Reference source not found. is at least one of:
a standalone device operable in said system; and
a functional subsystem in a device of combined functions in said system.

14. The Doppler group LIDAR receiver apparatus of claim Error! Reference source not found. further includes a least one of:
an optical module, coupled with the optical detector, for facilitating reception of light signals;
a filter and receiver module, coupled with the optical detector and the at least one mixer, for selectively blocking frequency components not of application concerns and amplifying wanted signal components;
at least one filter, coupled with the at least one mixer, for selectively blocking frequency components not of application concerns;
at least one amplifier, coupled with the at least one filter and the at least one mixer, for amplifying signals in baseband; and
at least one analog to digital converter, coupled with the at least one amplifier and the at least one filter, for digitizing signals in baseband channel; and
a digital signal processer, coupled to the analog to digital converter, for processing the baseband signal and obtaining wanted sensing results.

15. A transmitter apparatus in a system of Doppler group LIDAR, or group Doppler sensors over optical carrier, comprising:
a radio receiver, for locking to a broadcasted signal from an antenna, and deriving, from the broadcasted signal, at least one of a frequency reference signal and a timing signal;
a signal generator, coupled with the radio receiver, for generating, based on the at least one of the frequency reference signal and the timing signal, at least one of a first signal and a second signal, and building a modulating signal based on said at least one of the first signal and the second signal;
a module of light source and amplitude modulator, coupled with the signal generator, for modulating said modulating signal onto an amplitude of a light signal, and producing a modulated light signal;
whereby the transmitter apparatus is operable to
generate and use, at any time instant of operation, said at least one of the first signal and the second signal closely identical in frequency properties to any counterpart thereof generated elsewhere in other devices within the system of Doppler group LIDAR, or group Doppler sensors over optical carrier; and
transmit the modulated light signal.

16. The transmitter apparatus of claim Error! Reference source not found. is at least one of:
a standalone device operable in said system; and
a functional subsystem in a device of combined functions in said system.

17. The standalone device of claim Error! Reference source not found. is at least one of an active beacon apparatus operable in said system and attached to an object being sensed by said system; and
an illuminator apparatus operable in said system.

18. The illuminator apparatus of claim Error! Reference source not found. is installed on at least one of
a stationary platform; and
a movable reference platform.

19. The transmitter apparatus of claim Error! Reference source not found. further includes at least one of:
a light power amplifier, coupled with the module of light source and amplitude modulator; and
an optical module, coupled with one of the module of light source and amplitude modulator, and the light power amplifier, for facilitating emitting the modulated light signal.

20. The transmitter apparatus of claim Error! Reference source not found. is further operable to generate the first and second signals, if active, with magnitudes thereof based on at least one of:
a low data rate digital ID data sequence of said transmitter apparatus; and
a low frequency random waveform generated independently in said transmitter apparatus.
